(19) United States
(12) Patent Application Publication
(10) Pub. No.: US 2016/0165670 A1
(43) Pub. Date: Jun. 9, 2016

(54) Hair Appliances Heating Mat

(71) Applicant: TAI WAH DISTRIBUTORS PTE LTD, Singapore (SG)

(72) Inventors: Kok Swee TOH, Singapore (SG); Richard Brian Patrick DUNN, Harrogate (GB)

(21) Appl. No.: 14/907,566

(22) PCT Filed: Jul. 24, 2014
(86) PCT No.: PCT/SG2014/000348

§ 371 Date: Jan. 26, 2016

(30) Foreign Application Priority Data
Jul. 26, 2013 (SG) 201305737-7

(51) Int. Cl. H05B 6/10; H05B 6/36; H05B 6/06; A45D 4/16

(52) U.S. Cl. CPC H05B 6/10; A45D 4/16; H05B 6/36; H05B 6/06

(57) ABSTRACT

An induction-heater mat for heating up hair-styling appliance, the induction-heater mat comprises a mat that is made up of flexible material, the mat having an induction coil embedded therein; and a power supply and controlling unit that is electrically connected with the induction coil of the mat, the power supply and controlling unit operationally controls the power supply to the induction coil to heat up the hair-styling appliance that is placed on the mat.

### FIELD OF THE INVENTION

The present invention generally relates to hair styling appliances, and in particular to an induction heating mat adapted for heating hair styling appliances.

### BACKGROUND

Many hair styling appliances are required to be heated for styling hair. Depending on the use, different hair styling appliances have different ways of heating up. For example, curling tongs and hair straightening devices, such devices require electrical power to continuously heat up the heating elements thereon. Most commonly, the electrical power is supplied through a power cord/wire connected thereto. Such power cord/wire often gets in the users' way when they operate these appliances.

Induction heating pots offer a flexible way of heating up the appliances quickly and effectively. The heating pots are initially manufactured in a fixed size for adopting the appliances of the intended sizes, which are limited in options. Further, the pot is usually adapted for heating up one appliance at one time.

Further, such heating pots are relatively bulky, i.e. immobile, for carrying around. The size of the pot is a massive disadvantage as most salons have limited space.

Once the roller is placed into the pot it is only visible and accessible from the top. Small items could fall into the pot unbeknown to the user causing possible damage or even fire. Dust can settle and cleaning can be difficult.

The pot is very made from plastic and could easily be damaged if dropped on the floor.

### SUMMARY

In one aspect of the present invention, there is provided an induction-heater mat for heating up hair-styling appliances. The induction-heater mat comprises a mat that is made up of a flexible material, the mat having an induction coil embedded therein; and a power supply and controlling unit that is electrically connected to the induction coil of the mat, the power supply and controlling unit operationally controls the power supply to the induction coil to heat up the hair-styling appliance that is placed on the mat.

In one embodiment, the mat is fabricated form a monolithic body to house the induction coil there between. The mat may comprise two substrates, laminating the induction coil there between.

In another embodiment, the induction coil is made up of flexible, re shapeable wire. The induction coil may be positioned on the mat in a serpentine manner or a swirling manner.

In a further embodiment, the induction-heater mat may further comprise a sensor unit operationally detecting the temperature of the appliance and feeding back information to the power supply and controlling unit. The sensor unit may be embedded on the mat at a suitable location. Alternatively, the sensor unit may be positioned on the power supply and controlling unit.

In yet a further embodiment, the induction-heater mat may be a low/mid frequency induction-heater mat. The mat may be detachable from the power supply and controlling unit.

### BRIEF DESCRIPTION OF THE DRAWINGS

Preferred embodiments according to the present invention will now be described with reference to the figures accompanied herein, in which like reference numerals denote like elements;

FIG. 1 shows an induction-heater mat in accordance with one embodiment of the present invention;

FIG. 2 illustrates an induction-heater mat in accordance with another embodiment of the present invention;

FIG. 3 is a schematic depiction of the connections between the induction induction-heater mat and the power supply and controlling unit in accordance with one embodiment of the present invention;

FIG. 4 illustrates an operational usage of the induction-heater mat in FIG. 1; and

FIG. 5 illustrates an induction-heater mat in accordance with yet another embodiment of the present invention

### DETAILED DESCRIPTION

Embodiments of the present invention shall now be described in detail, with reference to the attached drawings. It is to be understood that no limitation of the scope of the invention is thereby intended, such alterations and further modifications in the illustrated device, and such further applications of the principles of the invention as illustrated therein being contemplated as would normally occur to one skilled in the art to which the invention relates.

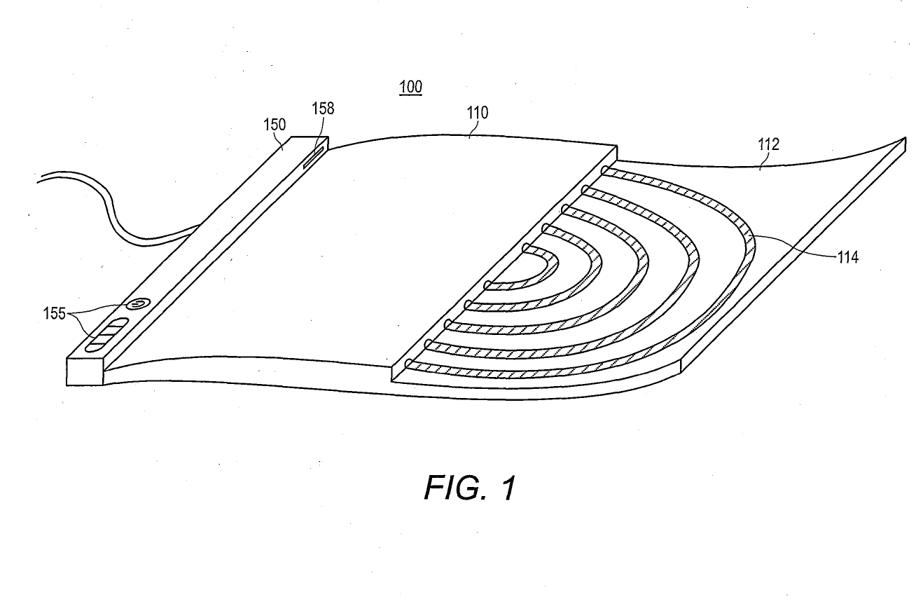

FIG. 1 shows an induction-heater mat 100 in accordance with one embodiment of the present invention. The induction-heater mat 100 is adapted to control and provide sufficient power to heat up hair styling appliances, such as hair rollers, hair brushes, curling tongs or the like, for styling hair. The induction-heater mat 100 is made with a flexible part for portability, and it is not limited to heat up only one appliance at one time. The induction-heater mat 100 may allow a plurality of appliances to be heated up simultaneously. Preferably, the appliances to be heated are made up of electrically conductive materials, such as iron-contained materials, or ferromagnetic-based materials, for heating up by the induction heater mat 100.

The induction-heater mat 100 comprises a mat 110 and a power supply and controlling unit 150. The mat 110 is attached to the power supply and controlling unit 150 physically and electrically. Operationally, the power supply and controlling unit 150 is connected to a power source. The user places the appliance to be heated on the mat 110 and powers up the power supply and controlling unit 150. The appliance to be heated may be heated up automatically once the power supply and controlling unit 150 is powered up, or user can operate the induction-heater mat 100 with the available operating modes controllable to heat up the appliances through the buttons 155 disposed on the power supply and controlling unit 150.

The mat 110 comprises a substrate layer 112 and a coil 114 embedded within the substrate layer 112. The substrate layer 112, which is preferably a flexible material formed in a mat form. In one embodiment, the substrate layer 112 is a dielectric material suitable for induction heating. The substrate layer 112 is made of high-temperature engineering thermoplastic which is the same as, or compatible with the materials of the other components and connectors of the heater so that, when at the end of the assembly process the components are laminated together. Preferably, the materials shall be able to fuse or bond the components (i.e. coil and connectors/terminators) to form a monolithic body and will not delaminate. The materials may include Poly(p-phenylene sulfide) (PPS), silicone, thermoset plastic, or any other known suitable materials. If another embodiments, the mat may be made up of any non-electrically conducted, rubberized material that is able to withstand heat of at least 150-200 degree Celsius.

The coil 114 illustrates in the FIG. 1 is disposed in a swirling-form over the substrate layer 112. The coil configuration and design is however not to be limited to such configuration. The size and shape of the coil can be altered accordingly to the mat size and shape and the intended heated object to ensure that a correct heat pattern can be obtained to maximize the efficiency of heating. Preferably, the coil 114 is made up of flexible, re-shapeable wire or wire assembly, for example, Litz-wire, that bundles a plurality of wires therein. However, the invention should not be restricted by this type of wire as other types may also be suitable.

In one embodiment, the substrate layer 112 may be fabricated through molding, extrusion or any known industrial process. It can be also made up of two thermoplastic sheets to sandwich the components between. Preferably, the stack of assembled components can be dispersed or merged into one another to form the monolithic unit when the thermoplastic material is heated to above its melt point and pressure applied.

In one illustrative example, a sheet of dielectric material can be cut into a desired shape and size form the substrate layer or half part of the substrate layer, a mask may be used to flame spray a conductive metal (e.g. copper) or metal alloy onto a main surface of the substrate layer 112 to form the coil 114. At this stage, all the necessary components, such as sensor(s), and the connectors/terminators can also be lay down accordingly. Once the components are set properly, another sheet of same dielectric material can be laid on top for sandwiching and sealing the components beneath.

The above is exemplified for illustrations only. It is understood that all known materials and fabrication methods suitable for fabricating the induction-heating mat 100 can be desired for the present invention.

Still referring to FIG. 1, the power supply and controlling unit 150 further comprises a sensor unit 158 disposed thereon. The sensor unit 158 is adapted for sensing the appliance to be heated up on the mat 110 in order to provide the necessary power controls, which include power cut-off, to prevent overheating. Preferably, the sensor is a contactless temperature sensor for sensing the temperature status of the appliance to be heated.

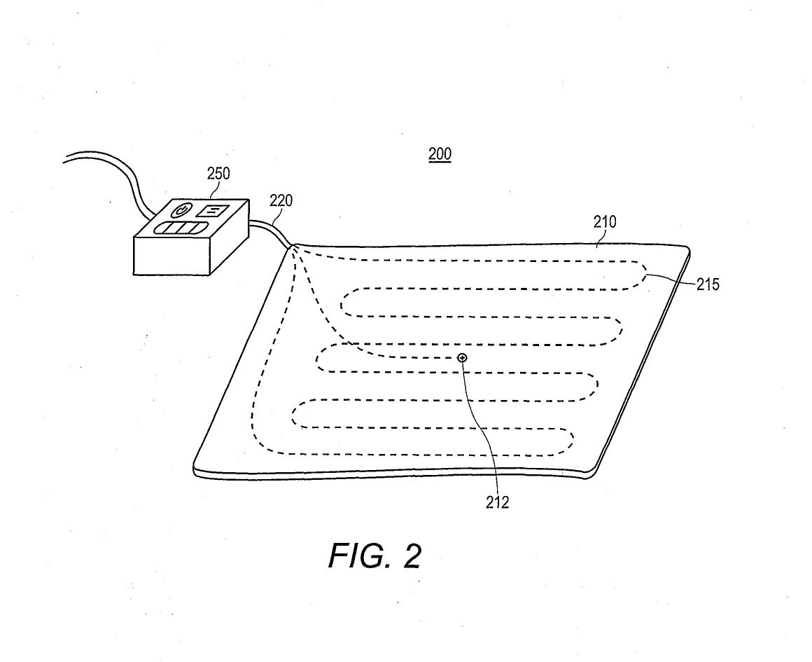

FIG. 2 illustrates an induction-heater mat 200 in accordance with another embodiment of the present invention. The induction-heater mat 200, unlike the mat 100 in FIG. 1, is adapted with a coil mat 210 and a power supply and controlling unit 250 fabricated as parted bodies but connecting with each other via a connecting wire 220. In this embodiment, a coil 215 is embedded within the coil mat 210 and disposed in a serpentine manner across the entire mat surface. The coil mat 210 further comprises a sensor 212 embedded at the center of the coil mat 210 for sensing the temperature status of the appliance to be heated.

The power supply and controlling unit 250 is adapted to supply power to the coil mat 210. The power supply and controlling unit 250 may be adapted to operate as a high-frequency power supply unit, or it can also be adapted to operate as a low to mid frequency power supply unit.

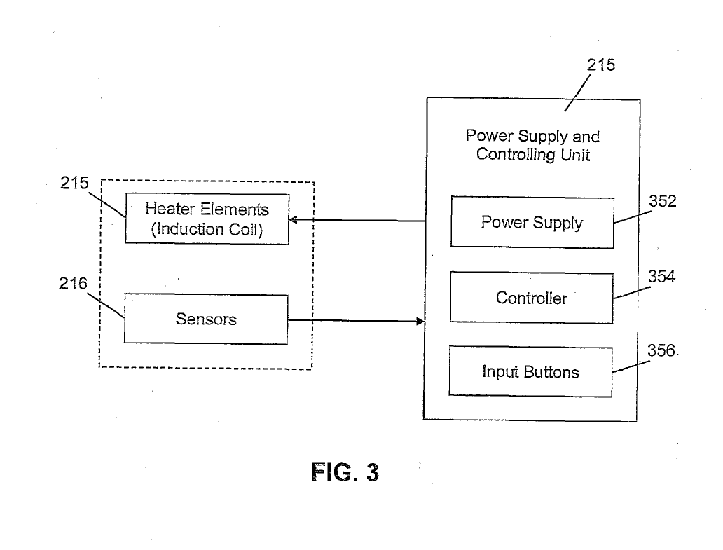

FIG. 3 is a schematic depiction of the connections between the induction induction-heater mat 200 and the power supply and controlling unit 250 in accordance with one embodiment of the present invention. The power supply and controlling unit 250 may further comprise a power supply 352, a controller 354 and input buttons 356.

Power supply 252 can be a low/mid-frequency power supply, and desirably, it is a mid-frequency power supply having an output frequency up to about 1.5 kHz. In another embodiment, the induction-heating unit that operates in the range of 80 kHz-120 kHz can also be desired, although the scope of the invention shall not be restricted to the suggested range of frequencies.

The controller 254 may include a microprocessor that receives inputs from the sensor(s) 212 and the input buttons 356 to control the heating power according to predefined operation modes stored on the controller 254. Operationally, the user selects an operating mode through the input buttons 356 to initiate a heating sequence to heat up the appliance. The heating sequence may include sensing the initial temperature of the appliance, heating up the appliance by supplying an appropriate power to the heater element (i.e. induction coil) 215, triggering a timer, monitoring the temperature of the appliance, cutting off the power when the timer has ended, or the temperature has reached a predefined threshold temperature.

In another embodiment, the power supply and controlling unit 250 may further comprise a display screen for outputting the operating statuses.

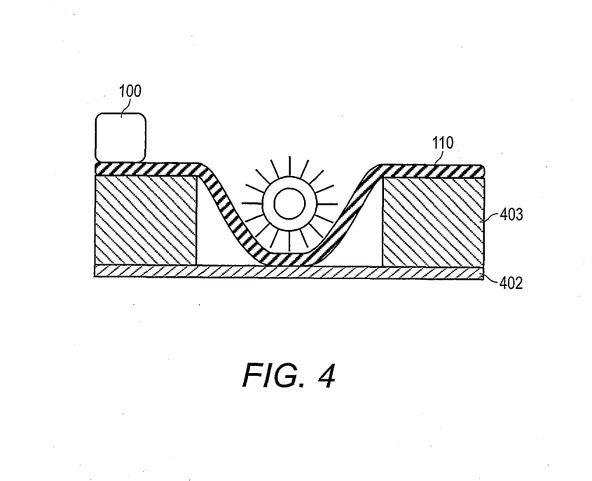

FIG. 4 illustrates an operational usage of the induction-heater mat 100. In this illustration, instead of having the mat 110 operationally lying flat on a flat surface 402, the user may place it on a depression allowing the mat 100 to bend up on the side to form a cavity such that the article or object to be heated within the cavity formed by the mat 100. In the absent of the depression, the user may simply place two blocks apart and place the mat 100 such that the two sides of the mat 100 is bent up to form the cavity so that the appliance can be heated up within the cavity in a similar manner.

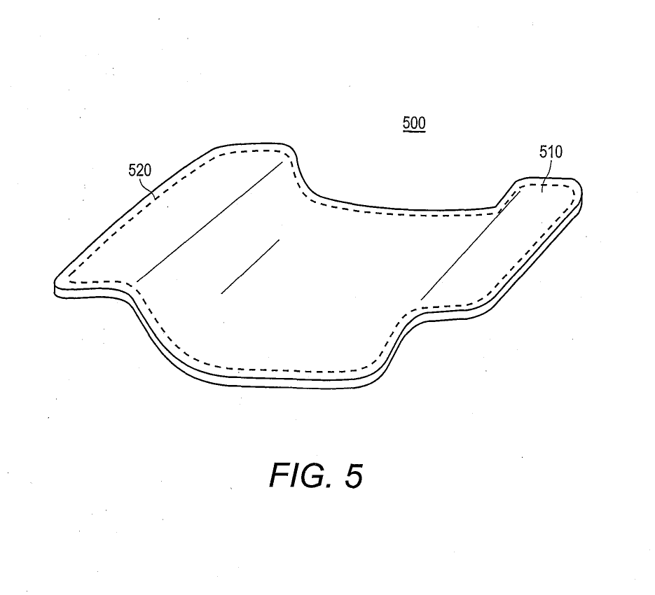

FIG. 5 illustrates an induction-heater mat 500 in accordance with yet another embodiment of the present invention. The induction-heater mat 500 is embedded with a wire-frame 520 alongside of the mat 510 of the induction-heater mat 500. Preferably, the wire-frame 520 is flexible wire that can be bent and reshaped along its length, which allows the sides of the mat 510 be held up themselves to form the cavity.

In one further embodiment, the induction-heater mat is battery operated.

In yet a further embodiment, the induction-heater mat of the present invention may include an appliance identifier for detecting the presence of the appliances and to detect the type of the appliances placing thereon. Such appliance identifier serves as a safety feature to operate the induction-heater mat. The induction-heater mat can be adapted to detect if the object that is placed on the mat is an appropriate appliance to be heated up. With the appliance identifier, the induction-heater mat can also detect the type and/or model of the appliances, which allows the power supply and controlling unit to operate automatically without the need of pressing any button as required above.

In one embodiment, the appliance identifier can be an optical scanner to scan an optical-readable tag that is provided on the appliance. In another embodiment, the appliance identifier can be a radio frequency (RF) reader for scanning a radio frequency identification (RFID) tag provided on the appliances.

While specific embodiments have been described and illustrated, it is understood that many changes, modifications, variations and combinations thereof could be made to the present invention without departing from the scope of the invention.

1. An induction-heater mat for heating up hair-styling appliances, the induction-heater mat comprising:
a mat that is made up of flexible material, the mat having an induction coil embedded therein; and
a power supply and controlling unit that is electrically connected to the induction coil of the mat, the power supply and controlling unit operationally controls the power supply to the induction coil to heat up the hair-styling appliance that is placed on the mat.

2. The induction-heater mat according to claim 1, wherein the mat is fabricated to form a monolithic body to house the induction coil there between.

3. The induction-heater mat according to claim 2, wherein the mat comprises two substrates laminating the induction coil there between.

4. The induction-heater mat according to claim 1, wherein the induction coil is made up of flexible, re-shapeable wire.

5. The induction-heater mat according to claim 1, wherein the induction coil is disposed on the mat in a serpentine manner.

6. The induction-heater mat according to claim 1, wherein the induction coil is disposed on the mat in a swirling manner.

7. The induction-heater mat according to claim 1, further comprising a sensor unit operationally detecting a temperature of the appliance and feeding back information to the power supply and controlling unit.

8. The induction-heater mat according to claim 7, wherein the sensor unit is embedded in/on the mat at a suitable location.

9. The induction-heater mat according to claim 7, wherein the sensor unit is positioned on the power supply and controlling unit.

10. The induction-heater mat according to claim 1, wherein the induction-heater mat is a low/mid frequency induction-heater mat.

11. The induction-heater mat according to claim 1, wherein the mat is detachable from the power supply and controlling unit.
